(19) United States
(12) Patent Application Publication
(10) Pub. No.: US 2026/0255312 A1
(43) Pub. Date: Aug. 27, 2026

(54) LOCATING SYSTEM

(71) Applicant: AS Stroemungstechnik GmbH, Ostfildern (DE)

(72) Inventors: Andreas Szeteli, Filderstadt (DE); Nico Fischer, Filderstadt (DE)

(21) Appl. No.: 19/538,030

(22) Filed: Feb. 12, 2026

(30) Foreign Application Priority Data
Feb. 20, 2025 (DE) 102025106365.6

(51) Int. Cl. H04W 64/00

(52) U.S. Cl. CPC H04W 64/00

(57) ABSTRACT

A locating system for containers, comprising: containers respectively including a container opening for filling in or removing goods, wherein the containers include slave containers and master containers, wherein only the master containers include a locating unit configured to determine a location of a master container as a location information, wherein only the master containers are able to communicate with a cloud-based computer system via an Internet connection, wherein each of the containers includes a data transmission module, wherein a data transmission module of a slave container sends signals to a data transmission module of a master container when the data transmission module of the master container is within range of the data transmission module of the slave container sending the signals, wherein the data transmission module of the slave container uses the signals to send container information of the slave container to the data transmission module of the master container.

### RELATED APPLICATIONS

This application claims priority from German Patent Application 10 2025 106 365.6, filed on Feb. 20, 2025, which is incorporated in its entirety by this reference.

### FIELD OF THE INVENTION

The invention relates to a locating system and a method for locating containers.

### BACKGROUND OF THE INVENTION

Such containers are generally used to store goods, in particular liquids. In general, the container has an opening via which the goods can be removed from or filled into the container.

In particular, the containers can be part of a removal system.

Such a removal system is known from EP 0 977 702 B1. This removal system is used for filling and emptying containers, in particular drums filled with liquid chemicals. Each container has a dip tube via which liquids stored in the container can be removed and via which liquids can be filled into the container. The removal system has a removal head that is connected to the dip tube of the respective container.

The removal head is then used to remove liquid from the container or, if necessary, to fill in liquid. For this purpose, a pump is connected via the removal head in order to remove or fill in liquid.

Once the removing or filling in of liquid has been completed, the container opening of the respective container is closed with a closing means. This being done, the container is ready for transportation. The container can then be transported, for example, to a place of use where the liquid is needed to carry out work processes or to a storage location.

An important task here is effective object tracking, i.e. it should be possible to continuously track containers during their transport in order to control transport processes, detect and correct misrouting of containers in good time and also to locate lost containers.

In principle, this object tracking can be carried out by means of GPS systems. However, such GPS systems are undesirably expensive. The containers must be fitted with GPS trackers with SIM cards. This results in undesirably high costs. In addition, the power consumption of such units is undesirably high.

### BRIEF SUMMARY OF THE INVENTION

The object of the invention is to provide a simple and efficient locating system for containers of a removal system.

The features of the independent claims are intended to provide a solution for this task. Advantageous embodiments and appropriate further developments of the invention are described in the dependent claims.

The invention relates to a locating system for containers, wherein the containers respectively have a container opening for filling in or removing stored goods. There are containers which are slave containers and containers which are master containers, wherein only the containers which are master containers each have a locating unit, their location information being the determined location of this container. Only the master containers communicate with a cloud-based computer system via an Internet connection. Each of the containers has a data transmission module, wherein a data transmission module of a slave container sends signals to a data transmission module of a master container if the data transmission module of the master container is within range of the data transmission module of the slave container sending signals. The data transmission module of the slave container uses the signals to send container information of this slave container to the data transmission module of the master container. The container information of the slave container, together with its location information, is sent by the master container to the cloud-based computer system via the Internet connection.

The Internet connection can be a WLAN connection or a mobile radio connection such as an LTE connection or a 2G, 3G, 5G, 6G mobile radio standard connection.

The invention also relates to a corresponding method. The basic idea of the invention is to design the containers of a container arrangement discriminately, in particular with regard to their communication means.

A small number of the containers are designed as master containers, while the majority of the containers are designed as slave containers.

Only the master containers have a locating unit such as a GPS module, i.e. a GPS tracker, so that only the master containers can determine their location as location information.

Furthermore, only the master containers can communicate with a cloud-based computer system via an Internet connection.

In contrast, there is one data transmission module in each container, wherein two data transmission modules, one in each container, form a data transmission link of limited range, i.e. if two containers are at a distance smaller than the range of the signals emitted by one data transmission module, they can be received by the other data transmission module.

The operating principle of the locating system according to the invention is such that the data transmission module of a slave container sends container information to the data transmission module of a master container by sending its signals when the master container is within range of the signals. The slave container uses the signals to send container information to the master container, which sends this container information together with the location information available in the master container to the cloud-based computer system via the Internet connection.

This container information is stored in the cloud-based computer system and can be analyzed there.

What is important here is that, because of the limited range of the data transmission link between the slave container and the master container, the location information of the master container can be used for the slave container sending the container information, to determine the position of the slave container with sufficient accuracy.

In this way, by communicating with a master container, slave containers can be located with sufficient accuracy without having to have locating units such as GPS modules themselves.

Generally, container arrangements with a large number of containers are transported together, i.e. the containers are located at small distances from one another, i.e. distances smaller than the range of the signals of the data transmission modules.

This means that a small number of master containers in the container arrangement is sufficient to locate a large number of slave containers. In borderline cases, even one master container may be sufficient for this purpose.

As only a small number of master containers are required, the number of costly locating units, in particular GPS modules, can be kept low, as only the master containers have the locating units, and not the slave containers, which only have data transmission modules that are considerably cheaper than the locating units.

As a result, the locating system according to the invention achieves a considerable savings effect compared to sensor systems in which all containers have a locating unit.

The containers and their container information are clearly identifiable.

For this purpose, the container information advantageously comprises an identifier that uniquely identifies the respective container.

Further advantageously, the container information may comprise sensor information of a sensor in or on the respective container.

In particular, the sensor(s) can be used to detect environmental influences acting on the respective container.

In particular, the sensor is a temperature sensor by means of which the temperature inside the container is captured.

If liquids are stored in the containers, the temperature sensor can be used to measure the temperature of a gas phase present in the container.

This makes it possible to recognize dangerous situations at an early stage.

Optionally, the container information can comprise parameters characterizing the respective container or its contents. Container information can be the article number, serial number or order number of a container.

Furthermore, the stored goods in the container can be identified by means of the container information. Advantageously, goods in the form of liquids are stored in the containers.

Such liquids can in particular be chemicals that are needed to carry out work processes, in particular in the semiconductor industry.

Container information can then contain the specification of the goods, in particular liquids stored in the container.

Alternatively, the parameters, together with the identifier of the respective container, can also be stored in the cloud-based computer system.

The function of the locating system according to the invention is such that a master container sends its own container information, as well as all container information read in from slave containers, to the cloud-based computer system.

Thus, using the location information, the cloud-based computer system performs time-dependent locating of the containers.

The location information is stored and evaluated in the cloud-based computer system together with the container information from the individual containers, wherein this information is uniquely assigned to the containers by the identifiers. This allows locating messages to be generated for different containers in the cloud-based computer system.

The locating message for each container is time-dependent, i.e. it is continuously updated so that a user can precisely track the transportation path of the container.

A user can retrieve location messages from containers at any time by means of a user unit and thus track their location in a time-dependent manner. The user unit is generally a computer unit. For example, the user unit can be a PC, a laptop, a smartphone or similar.

Advantageously, an app which enables access to the cloud-based computer system is available in the user unit. Access codes can be used to specify whether the user has access to all containers stored in the cloud-based computer system or only to a subset thereof.

According to an advantageous embodiment, a data transmission link is established between two data transmission modules of two containers, via which bidirectional data transmission takes place in the event that either data transmission module is within the range of signals sent by other data transmission modules.

Each data transmission module has a transmitter emitting signals and a receiver receiving signals from a further data transmission module.

In this case, communication takes place in such a way that the data transmission module of a master container sends a request to the data transmission module of a slave container. In response to this request, the data transmission module of the slave container sends its container information to the master container.

If multiple slave containers are arranged within the range of the data transmission link of the data transmission modules, multiple slave containers receive a request from the data transmission module of the master container. Slave containers whose data transmission modules received the request can then send their container information to the master container, wherein the signals from the individual slave containers are processed serially in the data transmission module of the master container.

The bidirectional data transfer between the data transmission modules also allows communication between data transmission modules of two slave containers, i.e. slave-slave communication takes place. In this way, container information from a slave container can be transferred to a further slave container. A master container can then retrieve the container information of multiple slave containers by sending a request to just one slave container.

According to an advantageous embodiment, the sending signals of the data transmission modules are Bluetooth signals.

Such Bluetooth data transmission links have ranges in the order of a few meters, possibly up to about 100 m (Bluetooth class 1).

According to an alternative embodiment, the data transmission modules are components of a decentralized mesh network. Here, the data transmission modules emit signals in the form of radio waves.

In such a mesh network, there is no control unit that regulates communication. Instead, each node in the network decides with whom it communicates. Each node can dynamically connect to other nodes and select the best communication path, in particular based on signal strength. The network can be scaled to any number of participants.

The ranges of such transmission systems are up to 200 m for radio waves in the GHz region.

According to an advantageous embodiment, the containers are part of a removal system.

In this case, it is practical that a dip tube opening out at the container opening is present in each container.

The dip tube can be closed at its outlet at the container opening with a dip tube closure. A removal head can be connected to the open dip tube as part of the removal system on the dip tube. Goods can be removed from or filled into the container via the removal head.

Advantageously, the data transmission module of a container is arranged in the outlet region of a dip tube or in the dip tube closure.

For containers without a dip tube, the data transmission module can also be integrated in a container closure.

More advantageously, the locating unit and the components of the Internet connection of a master container are arranged in the outlet region of the dip tube or in the dip tube closure.

### BRIEF DESCRIPTION OF THE DRAWINGS

The invention is now explained based on an advantageous embodiment with reference to drawing figures, wherein:

FIG. 1: shows a schematic representation of a removal system with an assigned container;

FIG. 2: shows a schematic representation of the locating system according to the invention; and

FIG. 3: shows a block diagram of the locating system according to the invention.

### DETAILED DESCRIPTION OF THE INVENTION

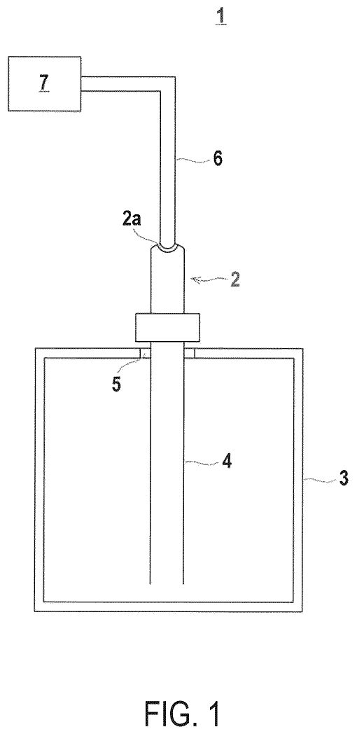

FIG. 1 shows a schematic representation of a removal system 1. The removal system 1 comprises a removal head 2, which can be attached to a container 3, which can be designed in particular like a drum. A liquid is stored in the container 3. Liquids stored in such containers 3 are in particular liquid specialty chemicals.

The container 3 has a dip tube 4. The dip tube 4 is mounted in a bung head, which sits in a container opening 5 of the container 3, and is thus firmly connected to the container 3. The longitudinal axis of the dip tube 4 runs in a vertical direction.

The removal head 2 is used to remove liquids from the container 3. Likewise, it can be used for filling containers 3. For this purpose, the removal head 2 has a liquid connection 2a at its upper end. A line 6 is connected to this liquid connection 2a, which leads to a pump 7. The line 6 can be designed as a hose.

The pump 7 is controlled by a control unit not shown.

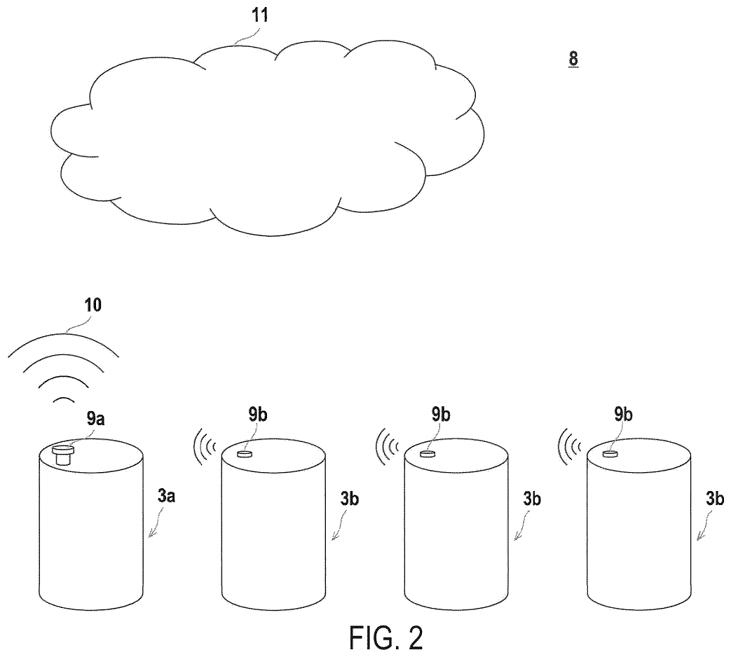

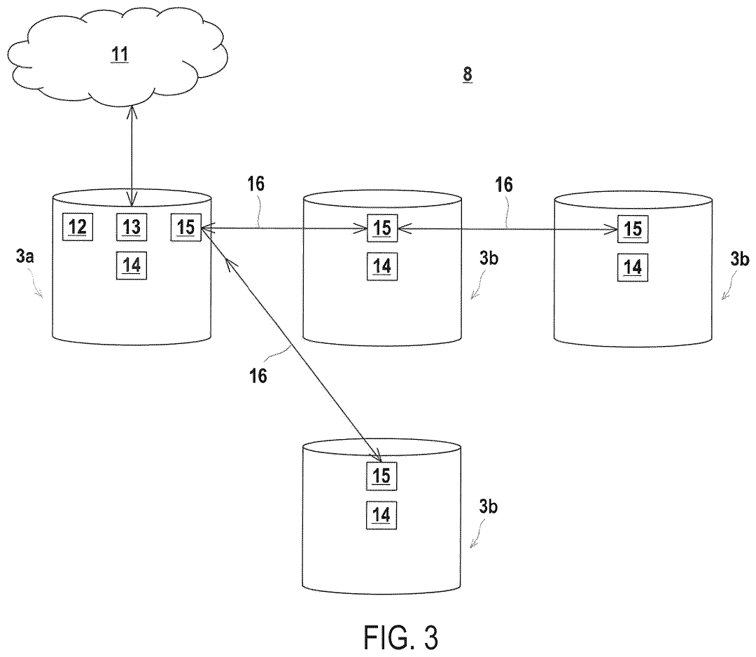

FIG. 2 shows a schematic representation of the locating system 8 according to the invention, FIG. 3 shows a block diagram of this locating system 8.

The locating system 8 comprises a container arrangement, which in the present case has four containers 3, wherein one container 3 is a master container 3a and three containers 3 are slave containers 3b. This number is by no means mandatory. In general, the locating system 8 can have a considerably larger number of containers 3. Multiple master containers 3a can also be provided, wherein their number is always considerably lower than the number of slave containers 3b. In the present case, all master containers 3a are designed identically. Likewise, all slave containers 3b are designed identically. However, this is not mandatory.

In the present case, the containers 3 are designed as drums.

In general, the containers 3 can also be designed as canisters, bottles, IBC containers or the like.

The containers 3 form transportable units. For transporting the containers 3, the openings 5 of each container are closed with a dip tube closure 9a, 9b.

The terms “master” and “slave” mean that the master containers 3a form superordinate units in relation to the slave containers 3b, in that only the master containers 3a can communicate with a cloud-based computer system 11 via an Internet connection 10.

Furthermore, a locating unit, in particular a GPS module 12, i.e. a GPS tracker, is provided only in that master container 3a (FIG. 3), by means of which locating unit the locations of the master containers 3a can be determined as location information.

FIG. 3 shows the electronic components that are present in the individual containers 3. The electronic components are arranged in the dip tube closure 9a, 9b of the respective container 3 and/or in the outlet region of the dip tube 4 into which the dip tube closure 9a, 9b is inserted. In addition to the GPS module 12, the master container 3a has a communication module 13 for establishing the Internet connection 10.

In particular, the Internet connection 10 is established via an LTE connection or a WLAN connection.

A temperature sensor 14 is provided in each container 3 for measuring the internal temperature of the respective container 3 or a gas phase present therein.

Furthermore, in each container 3, there is a data transmission module 15 with a transmitter emitting signals 16 and a receiver configured to receive signals 16 from a data transmission module 15 of another container 3.

The data transmission module 15 of two containers 3 is used to establish a data transmission link of limited range, i.e. the signals 16 emitted by the transmitter of one data transmission module 15 can be received by the receiver of the other data transmission module 15 if the data transmission modules 15 are arranged within range. Bidirectional data transmission takes place with the data transmission module 15.

The range is typically a few meters, up to a maximum of 100 m to 200 m.

In the present case, the signals 16 of the data transmission modules 15 are Bluetooth signals.

Alternatively, the data transmission modules 15 are components of a decentralized mesh network.

In this case, the data transmission modules 15 emit signals 16 in the form of radio waves.

Container information of the respective container 3 is stored in the containers 3, in particular in a storage module or process module integrated therein.

This includes an identifier that uniquely identifies the respective container 3.

Sensor information of the temperature sensor 14 also forms container information.

Optionally, container information can comprise parameters characterizing the respective container 3 or its contents.

According to the invention, use is made of the fact that container arrangements with a large number of containers 3 are transported together, wherein the distances between the containers 3 are small, in particular smaller than the ranges of the data transmission modules 15.

FIG. 2 shows the functional principle of the locating system 8 according to the invention.

In this case, the data transmission modules 15 of all slave containers 3b are within range of the master container 3a.

The master container 3a communicates directly with the cloud-based computer system 11 via the Internet connection 10 and sends its container information to the cloud-based computer system 11 together with the location information of the GPS module 12, which location information indicates the location of the master container 3a.

In the cloud-based computer system 11, the container information of the master container 3a is stored together with the location information of the master container 3a and can then be evaluated in the cloud-based computer system 11.

Since the slave containers 3b are arranged within range of the master container 3a, a data transmission link is established between the master container 3a and each slave container 3b via their data transmission module 15.

The master container 3a sends a request via the data transmission link to the respective slave container 3b, whose data transmission module 15 sends its container information to the master container 3a in response.

The master container 3a combines the container information of the respective slave container 3b with the location information of the GPS module 12 and sends this data to the cloud-based computer system 11.

In the cloud-based computer system 11, the containers 3 are clearly identified by their identifiers. The cloud-based computer system 11 contains the container information of all slave containers 3b, combined with the location information of the master container 3a. Since the data transmission link only has a limited range, the location information of the master container 3a also indicates the location of the slave containers 3b with sufficient accuracy.

This means that not only the master container 3a, but also all slave containers 3b can be located in the cloud-based computer system 11, preferably depending on time, without the slave containers 3b having to have their own GPS modules 12.

In the cloud-based computer system 11, the container information of all containers 3 is available combined with the location information and can be evaluated therein centrally. The evaluation results can be made available to a user, in particular via a local computer unit.

The data transmission module 15 can also be used for slave-slave communication, as shown in FIG. 3. This allows a slave container 3b to read container information into another slave container 3b.

This is advantageous if, as shown in FIG. 3, a slave container 3b is arranged farther away from the master container 3a so that it cannot communicate directly with the master container 3a. Even in this case, however, the container information of all slave containers 3b can be made available to the cloud-based computer system 11, as the more distant slave container 3b communicates with at least one other slave container 3b and can thus pass on its container information to this slave container 3b (FIG. 3), which then passes the container information on to the master container 3a.

### REFERENCE NUMERALS AND DESIGNATIONS

1 Removal system
2 Removal head
2a Liquid connection
3 Container
3a Master container
3b Slave container
4 Dip tube
5 Container opening
6 Line
7 Pump
8 Locating system
9a Dip tube closure
9b Dip tube closure
10 Internet connection
11 Cloud-based computer system
12 GPS module
13 Communication module
14 Temperature sensor
15 Data transmission module
16 Transmission signal

What is claimed is:

1. A locating system for containers, the locating system comprising:
containers respectively including a container opening for filling in or removing goods,
wherein the containers include slave containers and master containers,
wherein only the master containers include a locating unit configured to determine a location of a master container as a location information,
wherein only the master containers are able to communicate with a cloud-based computer system via an Internet connection,
wherein each of the containers includes a data transmission module,
wherein a data transmission module of a slave container sends signals to a data transmission module of a master container when the data transmission module of the master container is within range of the data transmission module of the slave container sending the signals,
wherein the data transmission module of the slave container uses the signals to send container information of the slave container to the data transmission module of the master container, and
wherein the container information of the slave container and the location information of the master container is sent by the master container to the cloud-based computer system via the Internet connection.

2. The locating system according to claim 1, wherein the container information includes an identifier uniquely identifying the respective container.

3. The locating system according to claim 1, wherein the container information includes sensor information from a sensor in or on the respective container.

4. The locating system according to claim 3,
wherein the sensor is a temperature sensor capturing a temperature inside the container, or
wherein the temperature sensor measures the temperature of a gas phase in the container.

5. The locating system according to claim 1, wherein the container information includes parameters characterizing the respective container or its contents.

6. The locating system according to claim 1, wherein a master container sends its own container information, as well as all container information read in from the slave containers, to the cloud-based computer system.

7. The locating system according to claim 1,
wherein the cloud-based computer system is configured to store and evaluate container information, and/or
wherein the location information of the containers in the cloud-based computer system is time based.

8. The locating system according to claim 1,
wherein the Internet connection is established via a mobile radio connection or a WLAN connection,
and/or wherein the locating unit is configured as a GPS module.

9. The locating system according to claim 1,
wherein a data transmission link is established between two data transmission modules of two containers, wherein the data transmission link provides bidirectional data transmission if one data transmission module is within a range of signals sent by another data transmission module,
wherein each data transmission module includes a transmitter emitting signals and a receiver receiving signals of another data transmission module.

10. The locating system according to claim 1,
wherein the signals of the data transmission modules are Bluetooth signals, or
wherein the data transmission modules are components of a decentralized mesh network.

11. The locating system according to claim 10, wherein the data transmission modules emit signals in a form of radio waves.

12. The locating system according to claim 1, wherein the containers are part of a removal system, wherein a dip tube leading into the container opening is provided in each container.

13. The locating system according to claim 12,
wherein the dip tube is closeable and openable by a dip tube closure at a dip tube outlet at the container opening, and
wherein a removal head is connectable to the opened tube as a component of the removal system, wherein stored material is removable from or fillable into the container through the removal head.

14. The locating system according to claim 13,
wherein characterized the data transmission module of the container is arranged in an outlet area of the dip tube or in the dip tube closure, or
wherein the locating unit and components of the Internet connection of the master container are arranged in an outlet area of the dip tube or in the dip tube closure.

15. A method for locating containers,
wherein each of the containers includes a container opening for filling in or removing goods,
wherein there are containers which are slave containers and containers which are master containers, wherein only those containers which are master containers include a locating unit which determines a location of the container as location information, and wherein only the master containers are able to communicate with a cloud-based computer system via an Internet connection;
wherein each of the containers includes a data transmission module, the method comprising:
a data transmission module of a slave container sending signals to a data transmission module of a master container when the data transmission module of the master container is within range of the data transmission module of the slave container sending signals;
the data transmission module of the slave container using the signals to send container information of the slave container to the data transmission module of the master container; and
sending the container information of the slave container by the master container with its location information to the cloud-based computer system via the Internet connection.
